(19) United States
(12) Patent Application Publication
(10) Pub. No.: US 2015/0183365 A1
(43) Pub. Date: Jul. 2, 2015

(54) Vehicle Headlight Protective Cover

(71) Applicant: Rawad Riad Aboughanem, Redondo Beach, CA (US)

(72) Inventor: Rawad Riad Aboughanem, Redondo Beach, CA (US)

(73) Assignee: Rawad Riad Aboughanem, Redondo Beach, CA (US)

(21) Appl. No.: 14/582,208

(22) Filed: Dec. 24, 2014

Related U.S. Application Data
(60) Provisional application No. 61/921,198, filed on Dec. 27, 2013.

(51) Int. Cl. B60Q 1/00; B60Q 1/04

(52) U.S. Cl. CPC B60Q 1/0005; B60Q 1/04

(57) ABSTRACT

An exterior vehicle headlight assembly protective cover, comprising of fabric or other material, extends across the front of the vehicle, covering the headlights of the vehicle. The protective cover blocks sunrays, dew, snow, ice, bird droppings, debris, and other elements when the vehicle is parked outside. The cover is dimensioned to cover the exterior of the vehicle headlight assemblies, by covering one headlight assembly then extending over across the front of the vehicle, over the grill area providing breathability to the vehicle grill area or over the hood area depending on the position of the headlights, then extending over and covering the second headlight assembly. The cover is held in place by a multitude of suction cups on the headlight assembly lens and surrounding area of the vehicle, including the front fenders.

### BACKGROUND OF INVENTION

(a) Field of the Invention

This invention relates to a flexible exterior headlight protective cover for receipt on top of a vehicle's front headlight assemblies, and more particularly, but not by way of limitation, to an all-year headlight protective cover that can be quickly secured to the exterior of the vehicle's headlights.

The cover is dual purpose by helping keep the headlights from oxidizing and fading in the summer, and protecting the headlights from snow and ice in the winter, when the vehicle is parked outside.

(b) Discussion of the Related Art

There are several known devices for covering the headlights of a vehicle. Most of these are localized headlight covers that provide visual enhancement to the headlights in the form of a rigid preformed plastic lens, typically tinted, mounted on top of the original headlight lens. Another type of these devices are the clear or tinted plastic films, typically adapted for vehicle window tinting, adhered permanently on top of the headlight lenses to provide aesthetic appeal or as mean of shielding the headlights from flying debris from other vehicles while the vehicle is moving.

In recent years, with the shift from glass vehicle headlight lenses to clear plastic headlight lenses, more vehicle exterior headlight lenses are experiencing damage that occurs from exposure to mother nature. Additionally, vehicles facing damaging sunrays, moisture, bird droppings face oxidation, fading, yellowing, discoloring, and possibly pealing of the headlight assembly lens in modern vehicles. Headlight assemblies may house side markers, parking lights, fog lights, and turn signals. So said damage to the headlight lenses may hinder the aesthetic appeal of the headlights. Additionally, such damage may also reduce the function and performance of the headlights, reducing visibility for the driver.

The damage appears in the form of oxidation. The damage appears in the form of fading. The damage appears in the form of yellowing. The damage appears in the form of pealing. The damage appears in the form of cracking.

While the above-mentioned patents describe and illustrate headlight covers, none of them specifically disclose the unique combination of structure, function, and advantages of the subject vehicle exterior headlight protective cover as described herein.

### BRIEF SUMMARY OF THE PRESENT INVENTION

The object of the invention is to provide means to protect the vehicle headlights from damaging outdoor environment. The headlight protective cover, covers the headlights, protecting the exterior lens of the vehicle headlight assemblies from damage, prolonging the clarity of the lenses, thereby extending the safe useful life of the headlight assemblies.

In view of the foregoing, it is a primary objective of the subject invention to provide an exterior vehicle headlight protective cover that blocks, may also reflect, the sun's rays and help protect the headlights from bird droppings, falling contaminants, rain, snow and ice when the vehicle is parked outside.

Another object of the invention is the cover can be quickly mounted on top of the headlights and securely held in tension hereon using a plurality of suction cups secured to the exterior of the vehicle's headlights, but not by way of limitation, over the general proximity of the headlight area which may include the headlight assembly, fenders, hood, and front bumper.

Another object of the protective cover is to provide breathability to the functional vehicle's front grill area in instances where the front grill crosses in the path of the protective cover once stretched over from one headlight assembly on one side of the vehicle over to the second headlight assembly on the opposite side of the vehicle.

The protective cover includes an exterior headlight cover member dimensioned to cover the exterior lens of the headlight assembly, including, but not by way of limitation, to the area surrounding the headlights which may include the fenders, hood, bumper, and grill.

The cover member includes a center portion, a first and second side portions. The first and second side portions include suction cups that are used to secure the said cover onto one or more of the following regions the headlight assembly lens including the parking light lens if separate, fender, hood, or bumper.

On the other hand, the center connecting portion, first side portion, and second side portion may also be constructed out of a single piece of material, being fabric, synthetic, or any other material.

These and other objects of the present invention will become apparent to those familiar with different types and designs of exterior front vehicle fascia cover and headlight protective covers when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE SEVERAL VIEWS OF THE DRAWING

The accompanying drawings illustrate complete preferred embodiments in the present invention according to the best modes presently devised for the practical application of the principles thereof, and in which:

FIG. 1 is a perspective view of the subject vehicle exterior headlight cover shown positioned above a vehicle's front fascia and ready for attachment thereto.

FIG. 2 is a perspective view of the backside protective cover displaying the soft flexible wiping tab.

FIG. 3 is another perspective view of the protective cover with a cover member received on top of the headlights and over the grill (while covering a portion of the hood), attached to the vehicle fenders and headlights with locking mechanism not engaged.

FIG. 4 is another perspective view of the protective cover with a cover member received on top of the headlights and over the grill (while covering a portion of the hood), attached to the vehicle fenders and headlights with locking mechanism engaged.

FIG. 5 is a perspective view of the protective cover with the cover member received on top for the headlights, grill, and front fascia of the vehicle, while being locked into place.

FIG. 6 is a perspective view of the protective cover wound into a compact roll and held in place using the elastic loops.

REFERENCE NUMERAL IN THE DRAWINGS

| | | | |
|---|---|---|---|
| 10 | headlight assembly protective cover | 12 | front headlight |
| 14 | vehicle | 16 | fender |
| 18 | hood | 20 | grill |
| 22 | front bumper | 24 | cover member |
| 26 | center connecting portion | 28 | center mesh portion |
| 30 | first side portion | 32 | second side portion |
| 34 | suction cup | 36 | locking suction cup with |
| | | | handle |
| 38 | elastic loop | 40 | lock |
| 42 | cleaning tab | 44 | inner layer |
| 46 | outer layer | 48 | logo |

### DETAILED DESCRIPTION OF THE INVENTION

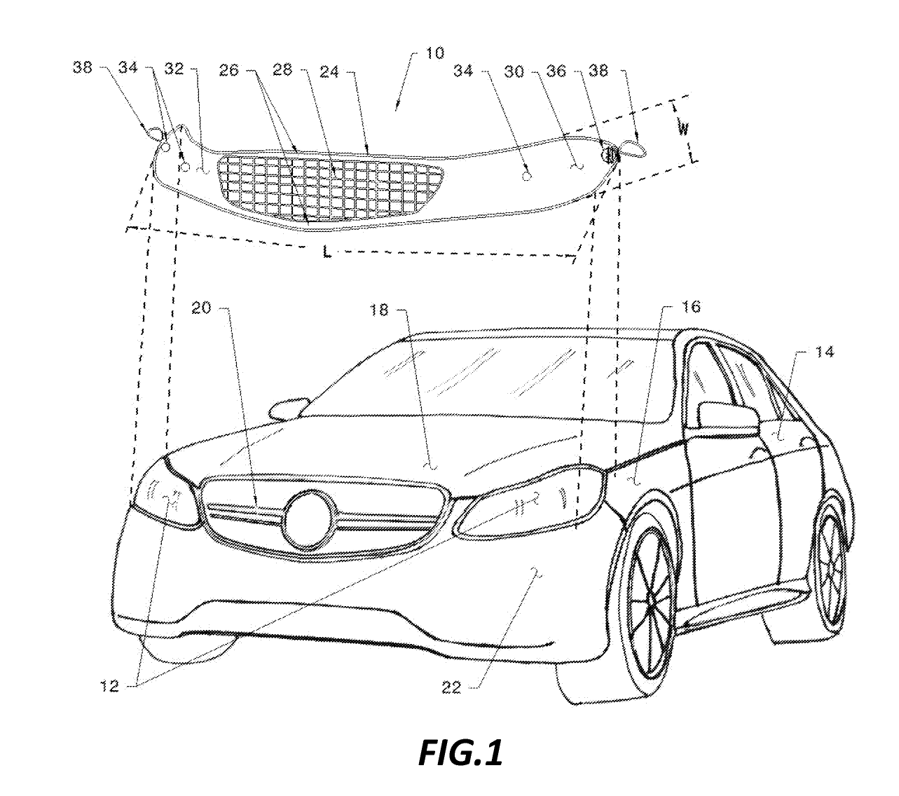

In FIG. 1, a perspective view of the subject vehicle exterior headlight assembly protective cover is shown having general reference numeral 10. The protective cover 10 is illustrated positioned above a vehicle's front headlights 12 and ready for attachment thereto. The headlights 12 are shown as part of a standard four-door sedan or vehicle 14. Obviously, the vehicle 14 can be of various types of automobiles, sports cars, sport utility vehicles, pickup trucks, semi trucks, recreational vehicles, off-road vehicles, and other vehicles. The vehicle 14 includes front fenders 16, hood 18, grill 20, and front bumper 22.

The protective cover 10 includes an exterior cover member 24 includes a pair of exterior headlight cover members 30 and 32 dimensioned to cover the exterior of the vehicles headlight assemblies 12. Cover member 24 dimensioned to cover the full exterior of the headlight assemblies 12.

The cover member 24 has a length “L” in the range of 50 to 108 inches and a width “W” of 2 to 24 inches wide. The cover member 24 includes center connecting portion 26, a first side portion 30 and a second side portion 32, an optional center mesh portion 28 as illustrated in FIG. 1.

The optional center mesh portion 28 that maybe included in the cover member 24 typically lies over the vehicle's grill 20 area and may take shape of the vehicle's grill 20 outline in the presence of a vehicle grill 20 lining up directly with the headlights 12. Lack of a grill 20 falling directly between the headlights 12, but not by way of limitation, where either the hood 18, the front bumper 22, and the front fenders 16 make up the portion directly between the headlights 12, the center mesh portion 28 may be closed off by adapting minimal cross sectional area of connecting section 26 to reduce fading of the vehicle's 14 paint in that area.

The cover member 24 including the first side portion 30 and second side portion 32 are connected by the center connecting portion 26, with an optional flexible center mesh portion 28 centered at the center connecting portion 26 between the first side portion 30 and second side portion 32.

The first side portion 30 includes a minimum of one suction cup positioned towards the outer side edge and the second side portion 32 includes a minimum of one suction cup positioned towards the outer side edge. The center area of the first side portion 30 and the center area of the second side portion 32 include a minimum of one suction cup. A minimum of one elastic loop is attached to the outer side edge of the first side portion 30 and the outer edge of the second side portion 32.

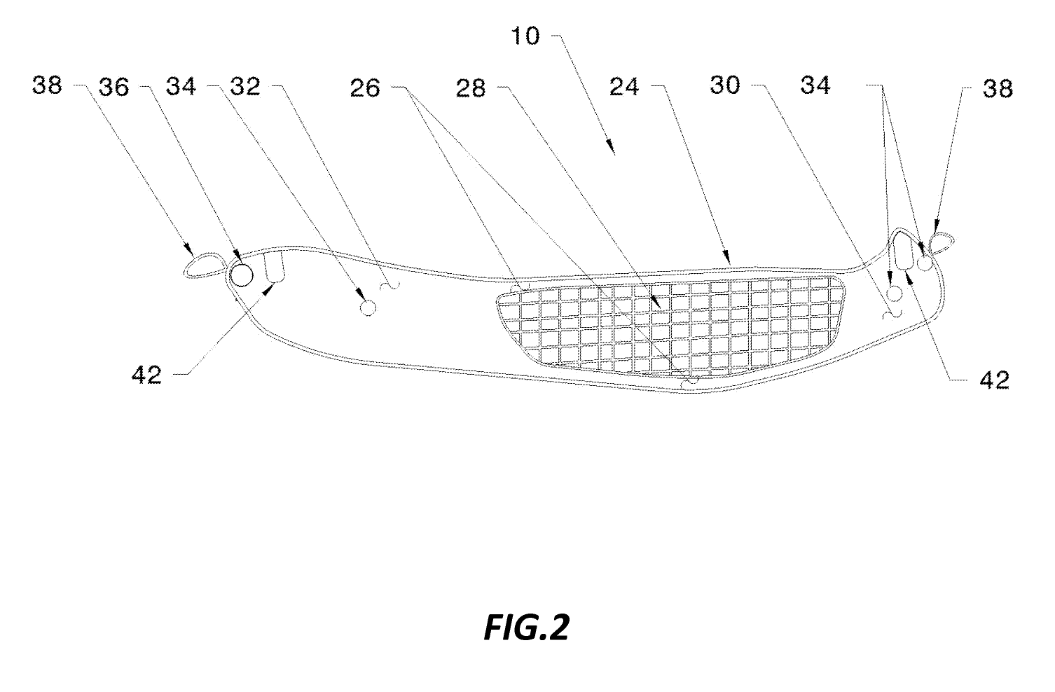

In FIG. 2 a perspective view of the back side of the flexible protective cover 10 is shown to include a soft fabric cleaning tab 42 used to wipe dust and dirt off the fenders 16 and headlights 12 to ensure a clean scratch free surface for the suction cups 34 to stick onto the designated areas.

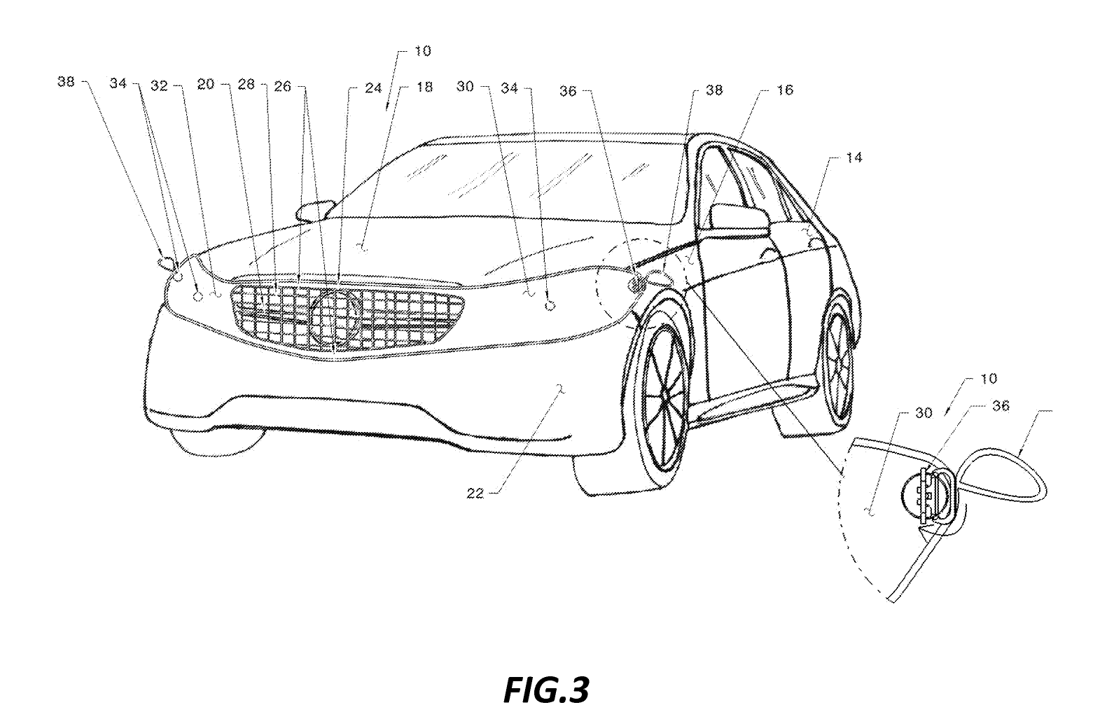

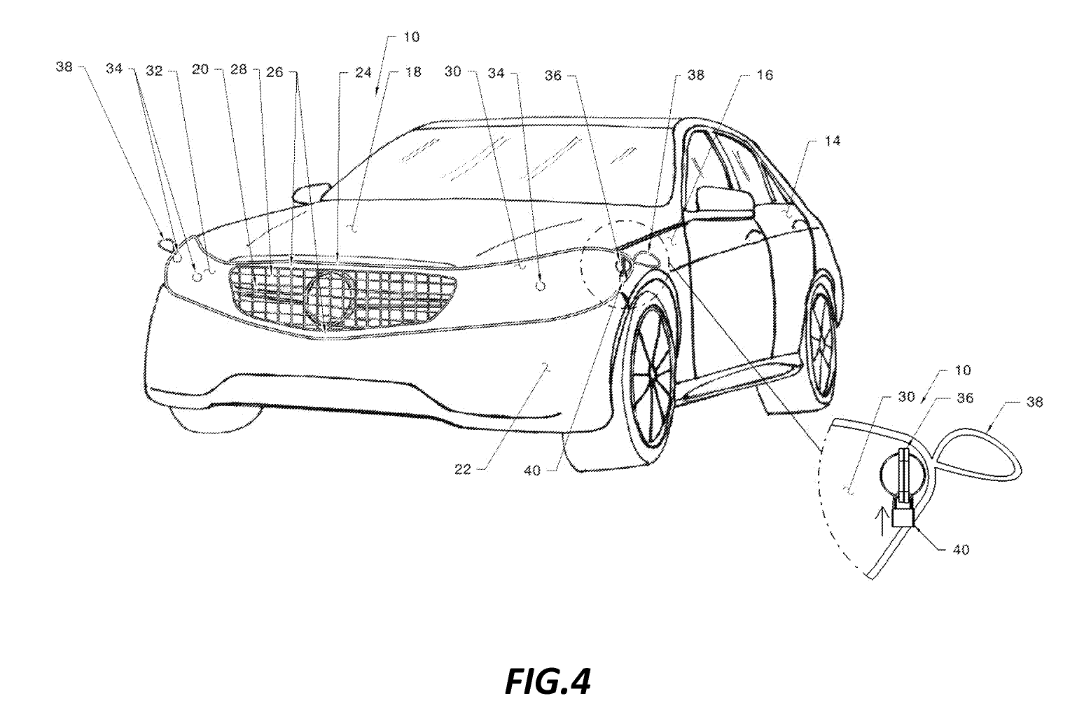

Suction cups 34 are used to secure the first side portion 30 and the second side portion 32 onto the fenders 16 against the headlights 12 in tension. Additionally, suction cups 34 are used to secure the first side portion 30 and the second side portion 32 onto the headlights 12 for holding the cover member 24 securely against the headlights 12. A minimum of two suction cups 34 are attached to the first side portion 30 and second side portion 32 to prevent the cover from lifting upwards at the center connecting portion 26 and at the optional center mesh portion 28 of the grill area under the tension imposed by the outer most suction cups 34 on the first side portion 30 and second side portion 32 of the cover member 24. This feature of the attachment of the suction cups 34 to the fenders 16 and the headlights 12 is shown in FIG. 3. To prevent theft of the protective cover 10, an optional locking suction cup with handle 36 positioned in place of one of the suction cups 34 used in conjunction with a lock 40 to secure the first side portion 30 or the second side portion 32 onto the headlight 12 or the fender 16 of the vehicle 14 as shown in FIG. 4.

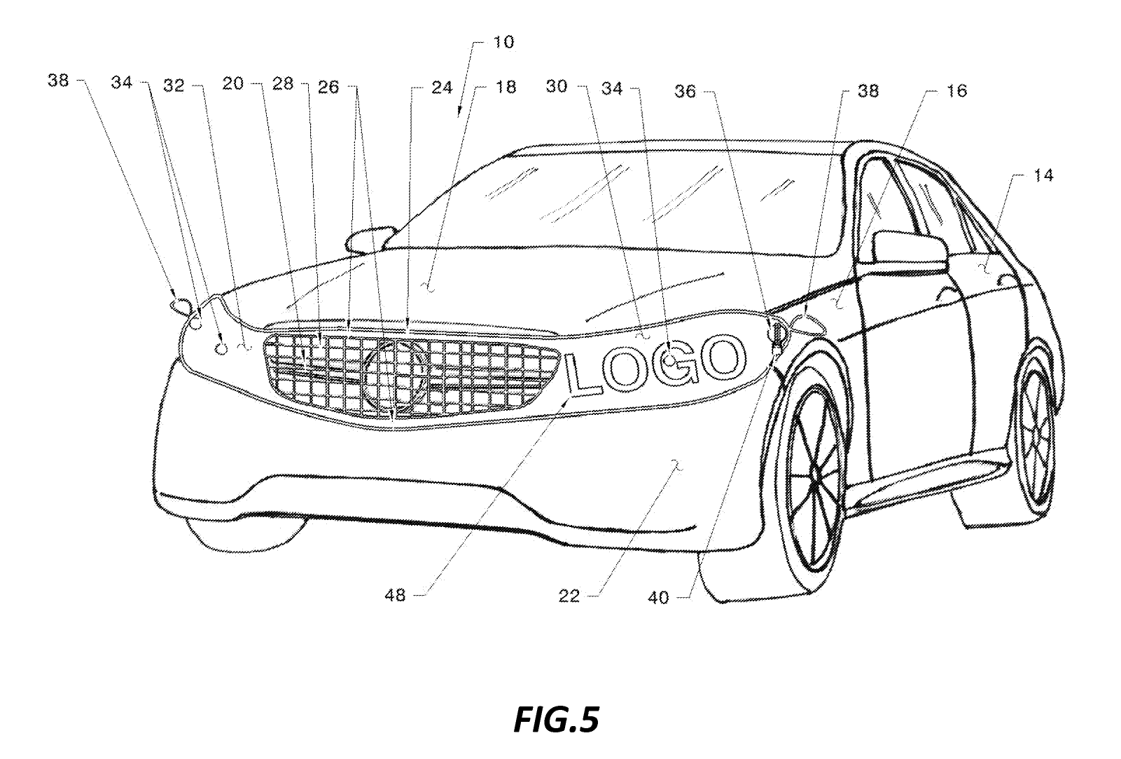

The headlight protective cover 10 may include a multitude of logos 48 and promotional material placed anywhere on the outside of the protective cover 10. For example, a logo 48 maybe applied to the outer surface of the first side portion 30, or the second side portion 32, or the center mesh portion 28, or the center connecting portion 26. In one embodiment, as illustrated in FIG. 5, a logo could be printed on, or embossed glued on, or stitched on, the first side portion 30.

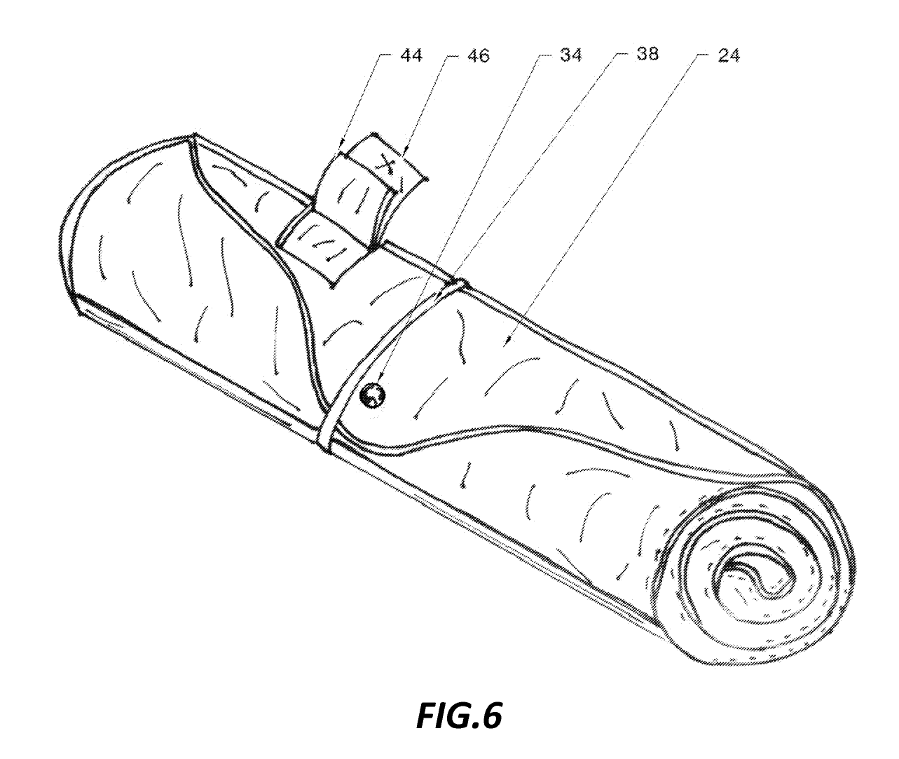

In FIG. 6, a perspective view of the flexible protective cover 10 is shown wound into a roll and held in place using elastic loops 38. In this drawing, a portion of the cover member 24 is cut away and folded back to illustrate a one or two or four ply material making up the cover 10. The material can include an outer layer 46, sun blocking or sun reflecting material made of a woven or non-woven fabric or reflective metal 22 foil or other material. For certain applications, the material can also include an inner layer 44, but not by way of limitation to a fabric material constructed of various thickness for adding insulation or soft texture to the protective cover 10.

The specification, including the drawings, describes preferred embodiments of the invention. Other embodiments within the scope of the claims herein will be apparent to one skilled in the art from consideration of the specification or practice of the invention as disclosed herein. It is intended that the specification be considered to be exemplary only, with the scope and spirit of the invention being indicated by the claims.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description and shown in the accompanying drawings shall be interpreted as illustrative and not in a limiting sense. In addition it should be understood that aspects of the various embodiments maybe interchanged both in whole or in part.

Having described my invention, I claim:

1. An exterior vehicle headlight assembly protective cover adapted for covering the exterior of the front headlights of the vehicle, the vehicle including front fenders, a hood, a front bumper, a grill. The protective cover extends across the front of the vehicle, covering the headlight assemblies of the vehicle. The protective cover blocks and or reflects sunrays, dew, snow, ice, bird droppings, and other elements when the vehicle is parked outside. When not in use, the protective cover is adapted for winding into a compact roll for storage. A protective cover for covering headlights of a vehicle, a protective cover comprising of:
a. A flexible headlight cover member adapted for and dimensioned to cover the vehicle's headlight assembly comprising of a first side portion, a second side portion, and a center connecting portion.
b. A flexible first side portion dimensioned to cover the vehicle's headlight assembly on one side, with one end extending over to the front fender. A minimum of one suction cup adapted on the first side portion to secure the first side portion to the exterior of the vehicle's fender thereby covering the outer edge of the headlights and preventing the cover from flopping in the wind, and a minimum of one suction cup adapted on the first side portion, close to the center connecting portion to secure the first side portion to the exterior lens of the vehicle's headlight assembly, thereby preventing the cover member from slipping up over the vehicle's grill and hood under tension.
c. A flexible second side portion dimensioned to cover the vehicle's headlight on second side, with one end extending over to the front fender. A minimum of one suction cup adapted on the second side portion to secure the second side portion to a portion of the exterior of the vehicle's fender thereby covering the edge of the headlights from flopping in the wind, and a minimum of one suction cup adapted on the second side portion to secure the second side portion to the exterior lens of the vehicle's headlight assembly close to the center connecting portion, thereby preventing the cover member from slipping up over the vehicle's grill and hood under tension.
d. An optional center mesh portion adapted within the center connecting portion constructed of mesh, stretchable net, or other flexible material connecting the first side portion with the second side portion of the vehicle, covers the vehicle's front grill while taking the shape of the vehicle's grill outline in instances where the vehicle grill lines up directly with the headlight assemblies providing breathability to the vehicle's grill once the vehicle is parked after use. Otherwise, the lack of a grill falling directly between the headlights, where either the hood and or the front bumper make up the portion directly between the headlights, the center connecting portion is adapted without the center mesh portion while utilizing smaller cross sectional center connecting portion to help reduce fading of the paint in that area.
e. On the other hand, the center connecting portion, first side portion, and second side portion may also be constructed out of a single piece of material that is cut into shape, being fabric, synthetic, or any other material. Additionally, an optional center mesh portion maybe constructed from the same piece that makes up the center connecting portion, first side portion, and second side portion, by cutting patterns into the center connecting portion depending on the vehicle requirements.

2. The protective cover as explained in claim 1 further includes an elastic loop attached to the outer side edge of the first side portion, opposite to the center portion, and an elastic loop attached to the outer side edge of the second side portion, opposite to the center portion, adapted for rolling and securing the protective cover from either end.

3. The protective cover as described in claim 1 wherein the cover member has a length “L” in the range of 50 to 108 inches and a width “W” of 2 to 24 inches wide for cover various types of vehicle and headlights.

4. The protective cover as described in claim 1 wherein the cover member including a sun blocking material, or a sun reflective material for blocking sun rays from passing through to the vehicle's headlight assembly lens.

5. The protective cover as described in claim 1 further including at least one logo or promotional material printed, glued, or stitched onto the first side portion, second side portion, center connecting portion, or center mesh portion.

6. An exterior vehicle headlight protective cover adapted for covering the outside of the vehicle's headlight assemblies, the vehicle including front fenders, hood, grill, and front bumper, the headlight assembly may include headlights, parking lights, blinkers, side markers, and exterior lens, the protective cover may do any single item or any combination of the following items including blocking the sunrays from reaching the vehicle's headlight assemblies, reducing the effects of the sunrays from reaching the vehicle's headlight assemblies, shielding the vehicle headlights from the harmful sun rays, depending on the material used, and to help protect the headlights from snow and ice in the winter while parked outside, when not in use, adapted for winding into a compact roll for storage, the protective cover comprising:
a. a flexible, exterior headlight cover member adapted for and dimensioned to cover the exterior of the vehicle's headlights, the cover member including a first side portion, a second side portion, and a center portion.
b. a flexible, center connecting portion with an optional center mesh portion disposed between the inner edge of the first side portion and the inner edge of the second side portion, covering the grill of the vehicle in cases where the grill falls directly between the headlights. Center connecting portion, but not by way of limitation, covers the hood, bumpers and portion of the fenders if they fall directly between the headlights.
c. a flexible, first side portion and second side portion including a multitude of suction cups and handles on the headlight area and fender area to secure the first side portion and the second side portion onto the exterior of the headlight assemblies and the fenders. An optional locking suction cup with handle and a lock is adapted in place of one of the suction cups as a means of security and to prevent the theft of the protective cover.
d. Additionally, a flexible, first side portion and second side portion including a multitude of suction cups adapted vertically near the outer side edges, secured on the vehicle fenders or headlights on either side of the vehicle in conjunction with a minimum of one suction cup adapted at the center connecting portion to hold the center connecting portion from sliding up over the bumper or hood.

7. The protective cover as described in claim 6 wherein the first elastic loop attached to the outside edge of the first side portion, a second elastic loop attached to the outside edge of the second side portion, the elastic loops received around the cover member for holding the cover member in a compact roll for storage.

8. The protective cover as described in claim 6 wherein the outer most suction cup adapted onto the flexible first side portion is secured first onto the exterior of the first front fender, then the vehicle headlight protective cover is further unwrapped by unrolling, then the remaining suction cups adapted on the first side portion are secured onto the exterior of the first headlight assembly, then the vehicle headlight protective cover is further unwrapped by unrolling exposing the center connecting portion and optional center mesh portion, then further unrolled exposing the second side portion at which the first suction cup adapted closest to the edge between second side portion and center portion is secured onto the exterior of the second headlight assembly, then the remaining suction cups are secured onto the exterior of the second front fender.
